(19) United States
(12) Patent Application Publication
(10) Pub. No.: US 2018/0292863 A1
(43) Pub. Date: Oct. 11, 2018

(54) FOLDING DISPLAY HINGE

(71) Applicant: Intel Corporation, Santa Clara, CA (US)

(72) Inventor: EDUARDO ESCAMILLA, Round Rock, TX (US)

(73) Assignee: Intel Corporation, Santa Clara, CA (US)

(21) Appl. No.: 15/482,301

(22) Filed: Apr. 7, 2017

(51) Int. Cl. G06F 1/16; E05D 7/00; F16C 11/04; E05D 3/06; E05D 11/00

(52) U.S. Cl. CPC G06F 1/1641; E05D 7/00; F16C 11/04; E05D 3/06; E05Y 2600/50; G06F 1/1626; G06F 1/1681; E05Y 2900/606; E05D 11/00

(57) ABSTRACT

Generally, this disclosure provides systems including one or more hinges to allow a multiple-screen display device to transition (or fold) between a fully open (“screens out”) configuration, a tablet configuration, a fully closed configuration, and a plurality of in-between angled configurations. The systems provided in this disclosure may further allow the screens in the “open” configuration to be positioned advantageously close to each other, minimizing the gap between them. Additionally, the systems and apparatuses described herein may facilitate transitioning between various orientations/configurations with beneficially minimal user input.

### TECHNICAL FIELD

The present disclosure relates to hinges for folding display devices.

### BACKGROUND

Tablet computers are well-established devices in households today, and yet are likely still in their adolescence in terms of feature development. One area of increasing interest is a “folding” tablet. While the concept of a folding display is not particularly new, such displays have thus far failed to break into the mainstream consumer space due to a variety of technological challenges. For example, display thickness, power consumption/battery size, bezel size, hinge design and sturdiness all present obstacles to handheld folding devices with more than one screen. As a result, current examples of these devices often have a significant gap between the viewing areas of their screens when in a tablet configuration.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates side views of an example hinge system in multiple configurations in accordance with embodiments described herein;

FIG. 2A illustrates a side view of an example hinge system consistent with at least one embodiment described herein;

FIG. 2B illustrates a side view of an example hinge system consistent with at least one embodiment described herein;

FIG. 2C illustrates a side view of an example hinge system consistent with at least one embodiment described herein;

FIG. 2D illustrates a side view of an example hinge system consistent with at least one embodiment described herein;

FIG. 3 illustrates a top-down view of example hinge systems consistent with at least one embodiment described herein;

FIG. 4 illustrates a side view of an example synchronous hinge system consistent with at least one embodiment described herein;

FIG. 5 illustrates a top-down view of an example device that may utilize one or more of the hinge systems consistent with at least one embodiment described herein;

FIG. 6 is a high-level logic flow diagram of an illustrative method of forming a hinge system consistent with at least one embodiment described herein; and

FIG. 7 is a high-level logic flow diagram of an illustrative method of forming a folding display device via rotationally coupling a first electronics housing to a second electronics housing consistent with at least one embodiment described herein.

Although the following Detailed Description will proceed with reference being made to illustrative embodiments, many alternatives, modifications and variations thereof will be apparent to those skilled in the art.

### DETAILED DESCRIPTION

Generally, this disclosure provides systems including one or more hinges to allow a multiple-screen display device to transition between a fully open (“screens out”) configuration, a tablet configuration, a fully closed configuration, and a plurality of in-between angled configurations. The systems provided in this disclosure may further allow the screens in the “open” configuration to be positioned advantageously close to each other, minimizing the gap between them. Additionally, the systems and apparatuses described herein may facilitate transitioning between various orientations/configurations with beneficially minimal user input.

With most hinged devices, the body of the hinge(s) is/are immobile relative to the device as the device is opened or closed. Thus, the two components of the device (e.g., electronics housings comprising screens, input devices such as keyboards, etc.) are displaced from each other by at least some amount relative to the size of the hinge. However, the 360° hinge system described in this disclosure includes a hinge and utilizes at least one recess, where the hinge is stowed inside the recesses while the device is in an “open” or “tablet” configuration. Put simply, the two electronics housings of the device have recesses for the body of the hinge to fit inside when the device is opened flat, beneficially allowing the electronics housings to slide closer together regardless of the size of the hinge. As the device is folded, the recesses rotate away from each other and the body of the hinge may translate and/or rotate out.

Some modern systems require users to maneuver electronics housings of the device in specific patterns to adjust the configuration/angle, due to the design of the hinge(s). Beneficially, the systems and embodiments described herein may enable users of the device to adjust the angle or configuration of a device intuitively by simply applying torque to the hinge system (e.g., by pressing/pulling an electronics housing of the device in the direction the user wants to adjust it). The specifics of the hinge, the recess, and the translation/rotation mechanisms enabling this advantage are described in further detail below.

A hinge apparatus to pivotably couple first and second electronics housings of a folding display device is provided. The hinge apparatus may include a hinge body; a first member at least partially disposed in a first recess formed in the first electronics housing, the first member pivotably coupled to the hinge body about a first axis of rotation, the first member biased along a first bias axis perpendicular to the first axis of rotation; and a second member at least partially disposed in a second recess formed in the second electronics housing, the second member pivotably coupled to the hinge body about a second axis of rotation, the second axis of rotation parallel to the first axis of rotation, the second member biased along a second bias axis perpendicular to the second axis of rotation.

A foldable display device is provided. The foldable display device may include a first electronics housing comprising a first display and a first recess formed in the first electronics housing; a second electronics housing comprising a second display and a second recess formed in the second electronics housing; and wherein the first electronics housing is rotationally coupled to the second electronics housing using at least one hinge system. The hinge system may include: a hinge body; a first member at least partially disposed in a first recess formed in the first electronics housing, the first member pivotably coupled to the hinge body about a first axis of rotation, the first member biased along a first bias axis perpendicular to the first axis of rotation; and a second member at least partially disposed in a second recess formed in the second electronics housing, the second member pivotably coupled to the hinge body about a second axis of rotation, the second axis of rotation parallel to the first axis of rotation, the second member biased along a second bias axis perpendicular to the second axis of rotation.

A method of forming a foldable display device is provided. The method may include: forming a hinge system, wherein forming a hinge system may include: pivotably coupling a first member to a hinge body about a first axis of rotation; biasing the first member along a first bias axis, the first bias axis perpendicular to the first axis of rotation; pivotably coupling a second member to the hinge body about a second axis of rotation, the second axis of rotation parallel to the first axis of rotation; and biasing the second member along a second bias axis, the second bias axis perpendicular to the second axis of rotation. The method may further include: forming a first recess in a first electronics housing; forming a second recess in a second electronics housing; and rotationally coupling the first housing to the second housing using the formed hinge system.

The terms “screens out” and “fully open” as used in the description of any embodiment or configuration herein are not used as terms of limitation, but merely as illustrative terms to simplify descriptions of those embodiments or configurations. The terms may be substituted or interchanged with no impact on the intended meaning or scope of the description of any embodiment. Similarly, the terms “tablet” and “flat” as used in the description of any embodiment or configuration herein are not used as terms of limitation, but merely as illustrative terms to simplify descriptions of those embodiments or configurations. These terms may also be substituted or interchanged with no impact on the intended meaning or scope of the description of any embodiment. The terms “arm” and “member” as used in the description of any embodiment or configuration herein are not used as terms of limitation, but merely as illustrative terms to simplify descriptions of those embodiments or configurations. These terms may also be substituted or interchanged with no impact on the intended meaning or scope of the description of any embodiment.

Some Figures include an XYZ compass to denote a 3-dimensional coordinate system. This is included and used for clarity and explanatory purposes only; the embodiments depicted are not intended to be limited by the inclusion or use of such a coordinate system. The labels or directions may be substituted or interchanged with no impact on intended meaning or scope.

The terms “first” and “second” are similarly used herein as relative terms for simplification purposes only, and may be substituted or interchanged with no impact on intended meaning or scope. The terms “height,” “width,” “length,” and “depth” are similarly used herein as relative terms for simplification purposes only, and may be substituted or interchanged with no impact on intended meaning or scope.

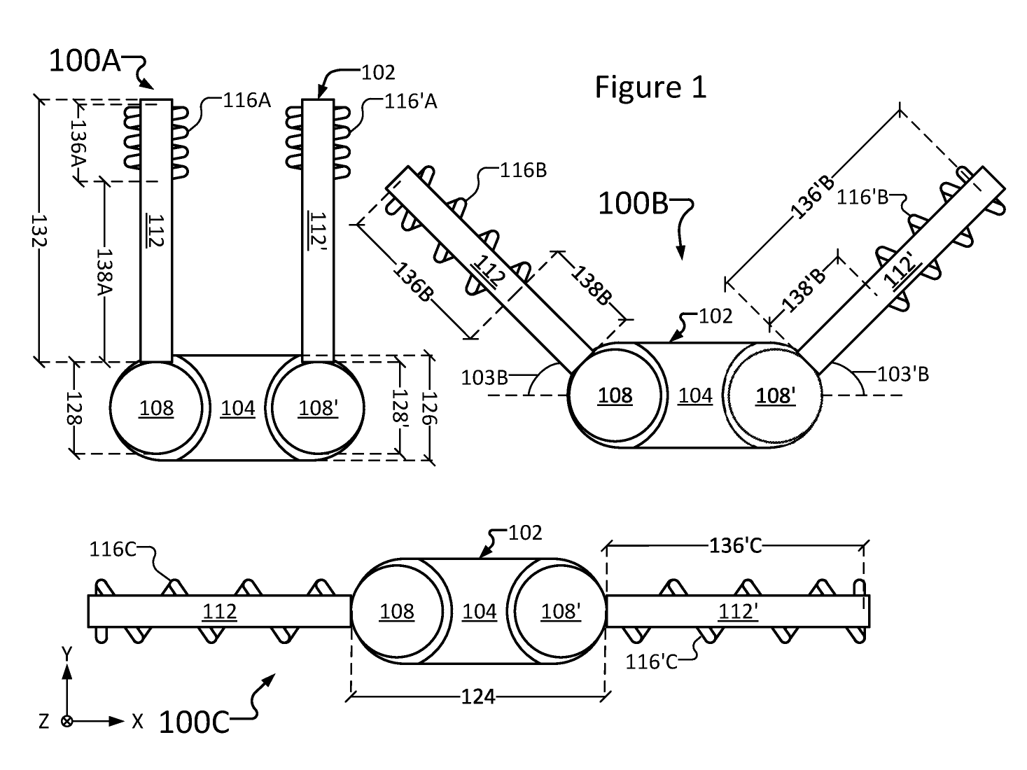

FIG. 1 illustrates side views of an example hinge system 102 in multiple configurations in accordance with embodiments described herein. The configurations depicted in FIG. 1 include “closed” configuration 100A, “angled” configuration 100B, and “tablet” configuration 100C. As a 360° hinge system, hinge system 102 may open from closed configuration 100A, through tablet configuration 100C and even further into a “fully open” configuration (not shown in FIG. 1), as will be described in further detail below. In any of these or other configurations, hinge system 102 may be connecting two electronics housings of a device (not shown in FIG. 1), as will be described in further detail below.

Hinge system 102 contains several subcomponents, including body 104 (or “housing” 104), hinges 108 and 108′, members (or “arms”) 112 and 112′, and springs 116 and 116′. Note that several subcomponents of hinge system 102 may have counterpart subcomponents (e.g., spring 116 has counterpart spring 116′). Subcomponents and their counterparts may function similarly to each other, though not necessarily identically.

The subcomponents of hinge system 102 may be made of any one of a plurality of materials, including metals (steel, aluminum, etc.), plastics, composites, etc. The subcomponents of hinge system 102 may be manufactured using typical methods including, for example, casting, milling, metal injection molding (MIM), additive manufacturing (“3d printing”), etc. MIM may be particularly advantageous in some embodiments as it allows for high-tolerance manufacturing of small metal parts. Different subcomponents (including counterparts) may be made of different materials.

Dimensions of the subcomponents of hinge system 102 may vary, though dimensions of some subcomponents may be interrelated, as will be discussed in further detail below. In some embodiments, body width 124 of hinge body (or “housing”) 104 may be any one of a plurality of values from, for example, 15 mm to 30 mm or greater. In some embodiments, body height 126 of hinge body 104 is greater than or equal to diameter 128 of hinge 108. Diameter 128 of hinge 108 may be any one of a plurality of values ranging from, for example, 5 mm or greater, 10 mm or greater, 12 mm or greater, 15 mm or greater, 30 mm or greater, etc. Springs 116 and 116′ may serve to assist a user of the device (not shown in FIG. 1) in manipulating the configuration or angle of the device.

Closed configuration 100A represents a state of example hinge system 102 wherein the device (not shown in FIG. 1) is fully closed. Here, the arms 112 and 112′ are parallel and hinge body 104 has translated out of the recesses, as will be discussed in further detail below. Notably in the closed configuration, spring 116 may be in a compressed state (i.e., spring length 136A is at a relative minimum, spring displacement 138A is at a relative maximum). Spring 116 may be positioned around a track (not visible in FIG. 1) to keep it aligned along member 112.

Angled configuration 100B represents a state of example hinge system 102 wherein the device is opened at an angle, such as angle 103B. Angle 103B may be, for example, 5 degrees or greater, 12 degrees or greater, 45 degrees or greater, 80 degrees or greater, etc. In some embodiments, hinges 108 and 108′ may be friction hinges (hinges including torque mechanisms (not visible in FIG. 1)) which may generate torque using a circumferential friction force between a collet and axle of each hinge. This friction force may be exerted upon or transferred to members 112 and/or 112′. Friction hinges may be set to offset the torque resulting from the spring force of springs 116′ and 116, respectively, as well as the torque resulting from the weight of the electronics housings of the device. For example, hinge 108 may have an internal torque setting of 0.5 kg*cm or greater, 1.5 kg*cm or greater, 2.5 kg*cm or greater, 5 kg*cm or greater, 10 kg*cm, etc. In this way, the device may advantageously remain at an angled configuration such as angle 103B of 100B without any additional input from a user (e.g., without holding it in place manually, using a lock, etc.). In some embodiments, hinge system 102 is a synchronous hinge, such that angle 103B is proportional (and possibly equivalent) to angle 103′B. In other embodiments, hinge system 102 is not synchronous, and therefore angles 103B and 103′B may not be directly related.

Depending in part upon the torque setting of hinges 108 and 108′, hinge system 102 may enable a user to manipulate the angle of the device with relative ease. In configuration 100B, spring 116 has been allowed to expand; i.e., spring length 136B is greater than 136A of closed configuration 100A, while spring displacement 138B is lower than 138A. The extent of the expansion of spring 116 (and 116′) may depend upon the current angle, e.g. 103B, of the device.

Tablet configuration 100C represents a state of example hinge system 102 wherein the device is opened into a flat state. In some embodiments where the two electronics housings of the device both have screens, the tablet configuration may provide benefits such as allowing users to utilize and view both screens simultaneously, allowing the device to rest securely on a flat surface, etc. In this configuration, hinge body 104 has translated fully into the recesses (not shown in FIG. 1) of the electronics housings of the device, as will be described in further detail below. This translation allows hinge body 104 to be stowed inside the device itself in the tablet configuration, which in turn advantageously allows the electronics housings of the device to slide closer together. This is particularly advantageous in the embodiment where the two electronics housings of the device each have screens, as it reduces the gap or “seam” between the screens.

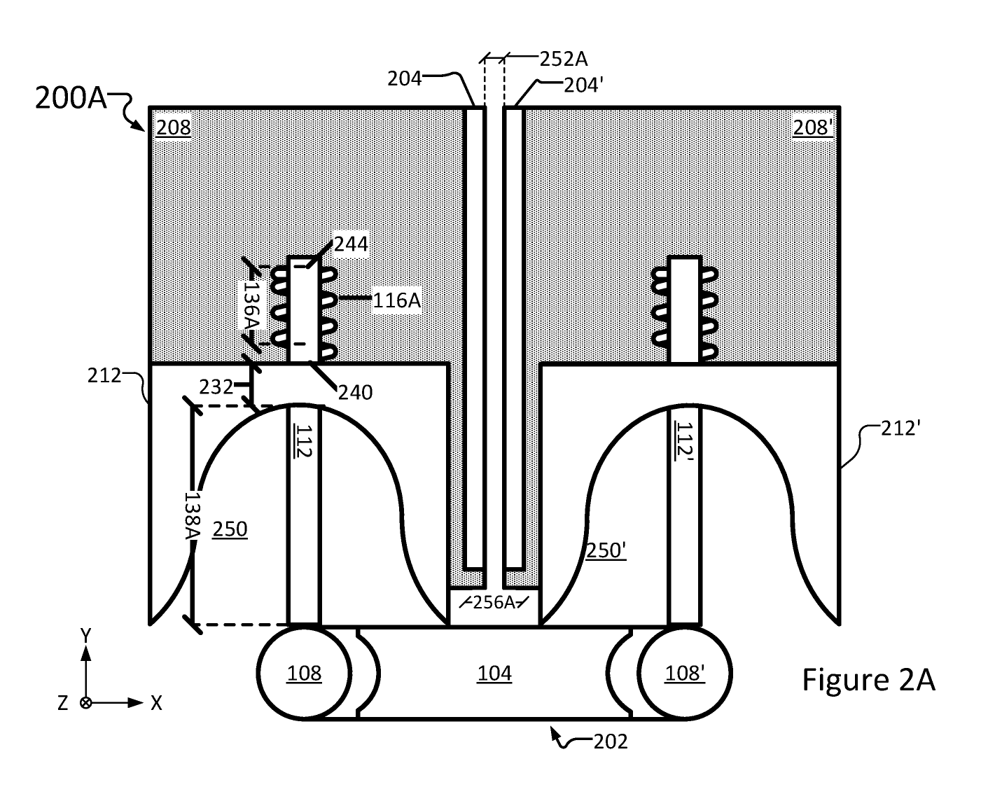

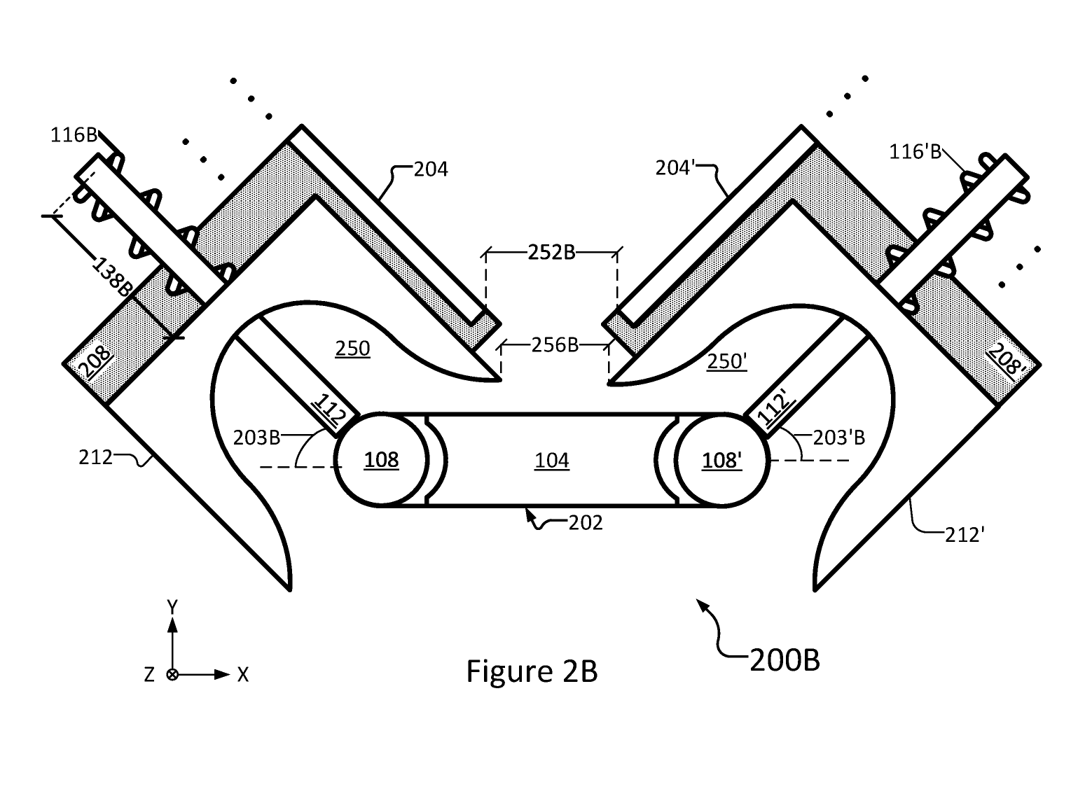

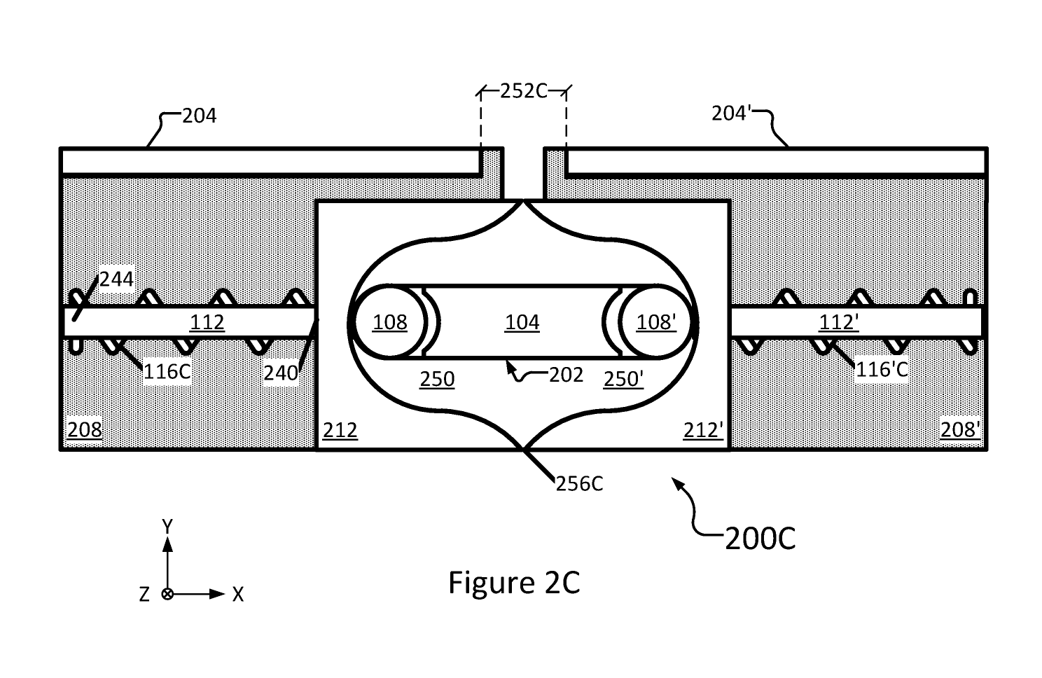

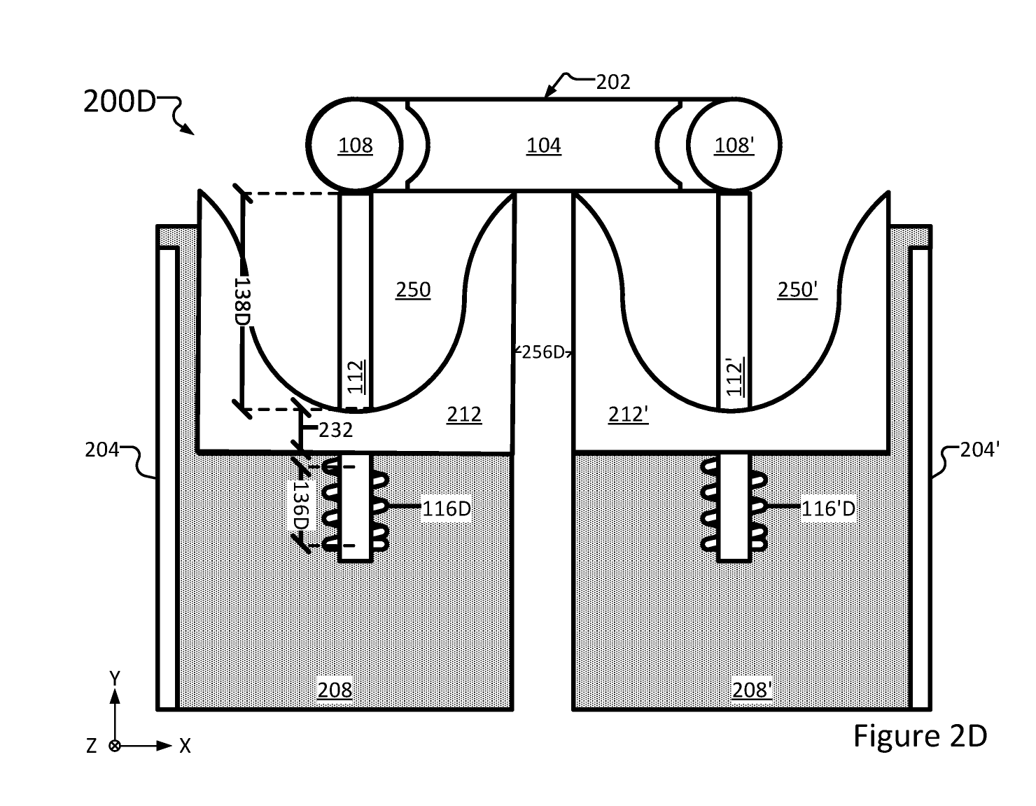

FIG. 2A illustrates a side view of an example hinge system 202 consistent with at least one embodiment described herein. The example embodiment illustrated in FIG. 2A additionally illustrates device electronics housings 208 and 208′, including screens/displays 204 and 204′, as well as recesses 250 and 250′. Note while that electronics housings 208 and 208′ and screens 204 and 204′ are depicted as rectangular in FIG. 2A, this is meant merely as an example of one embodiment and is not meant to limit the scope of this disclosure. Electronics housings 208 and 208′ and screens 204 and 204′ may take any of a variety of shapes or other forms.

In some embodiments, electronics housings 208 and 208′ may be components of a folding computing device or folding display device, and may include subcomponents including, for example, batteries, processors, memory, etc. In some embodiments, only one electronics housing 208 includes a screen 204, for example a laptop computer wherein electronics housing 208 represents a “display part” with screen 204 and electronics housing 208′ represents a “keyboard part” with no screen 204′. In other embodiments, neither electronics housing 208 or 208′ includes a screen. Such a no-display device could include, for example, a folding keyboard wherein electronics housings 208 and 208′ each represent a portion (e.g., roughly half) of the keyboard. Hinge system 202 is depicted in FIG. 2A in the closed configuration 200A, similar to configuration 100A of hinge system 102 as illustrated in FIG. 1. When in the fully closed configuration, in some embodiments electronics housings 208 and 208′ may have a gap between them (e.g., gap 252A between screens 204 and 204′). Gap 252A may be any of a plurality of values including, for example, 0.1 mm or greater, 0.5 mm or greater, 1 mm or greater, 5 mm or greater, 10 mm or greater, etc. In other embodiments, there may not be a gap (gap 252A may approach zero), i.e. electronics housings 208 and 208′ or screens 204 and 204′ may be in contact when the device is in the fully closed configuration such as 200A. In some embodiments, recesses 250 and 250′ may be cut out of garages 212 and 212′, respectively. In the same or other embodiments, garages 212 and 212′ may be partially or fully within electronics housings 208 and 208′. In the same or other embodiments, recesses 250 and 250′ may simply be cutouts or cavities of electronics housings 208 and 208′.

As illustrated in FIG. 2A, in some embodiments member 112 may extend through recess 250 and into electronics housing 208. Thus, in some embodiments member 112 may be biased along an axis extending from hinge 108, perpendicular to axis of rotation of member 112 about hinge 108, into electronics housing 208. Similarly, member 112′ may be biased along a different axis extending from hinge 108′, perpendicular to the axis of rotation of member 112′ about hinge 108′, into electronics housing 208′. Electronics housing 208 may have a member cavity or carveout beneath the surface of recess 212 to enable member 112 to freely translate into and out of electronics housing 208. Spring 116 may be partially or fully enclosed within electronics housing 208. In embodiments where recess 250 is cut out of a garage 212, garage 212 may be made of any of a variety of materials, including, for example, metals, plastics, composites, etc. In the same or other embodiments, the surface of recess 250 may have one or more holes, tunnels, canals, or carveouts (not visible in FIG. 2A) to allow member 112 to translate as the device angle is changed. The surface of recess 250 may have a back wall thickness 232 of, for example, 5 mm or greater, 10 mm or greater, 20 mm or greater, etc. In some embodiments, spring 116 may have one end anchored, connected, or otherwise coupled to recess 212 (e.g., at point 240) and a second end anchored, connected or otherwise coupled to member 112 (e.g., at point 244). In these embodiments, as member 112 translates through recess 250 further into or partially out of electronics housing 208, spring 116 expands and compresses.

Notably, in the embodiment illustrated in FIG. 2A, recess 250 has a curved cutout shape. In other embodiments, recess 250 may be any of a plurality of shapes, including straight lines, cylindrical, spherical, irregular, etc. The shape of recess 250 may enable hinge body 104 to rotate and/or translate in/out of recess 250 to/from a “stowed” state (e.g., when the device is in the tablet configuration) from/to an “exposed” state (e.g., when the device is in the closed configuration, as depicted in FIG. 2A) without binding, jamming, or otherwise contacting the surface of recess 250. The dimensions of recess 250 may vary depending on, for example, the translation length of member 112 (i.e., as the maximum of spring displacement 138 increases, dimensions of recess 250 may tend to decrease). More relationships between the dimensions of recess 250 and hinge system 202 may exist.

FIG. 2B illustrates a side view of an example hinge system 202 consistent with at least one embodiment described herein. Screens and electronics housings 204, 204′, 208, and 208′ appear smaller in FIG. 2B when compared to FIG. 2A, but as discussed above, their shapes are presented merely as illustrative examples and may vary.

The hinge system 202 of FIG. 2B is in an angled configuration 200B, similar to configuration 100B of hinge system 102 as illustrated in FIG. 1. As with configuration 100B, angle 203B of 200B may be any of a plurality of angles, including, for example, 5 degrees or greater, 15 degrees or greater, 80 degrees or greater, etc. As hinge system 202 may be synchronous, angle 203B may be proportional (and possibly equivalent) to angle 203′B. In some embodiments, hinge system 202 is not synchronous, and therefore angles 203B and 203′B may not be directly related. As recesses 250 and 250′ are rotated when compared to configuration 200A, the gap 256B between them may have changed. The gap between screens 204 and 204′, 252B, may also have changed.

As the device angle 203 is adjusted, for example from closed configuration 200A through angled configuration 200B, members 112 and 112′ may “swing” away from each other about hinges 108 and 108′. As members 112 and 112′ protrude through recesses 250 and 250′ into electronics housings 208 and 208′, the motion of members 112 and 112′ causes recesses 250 and 250′ to rotate around hinge body 104. As in this embodiment, springs 116A and 116′A are compressed in orientation 200A, they exert an outward force on both of their connection points (240 and 244, as depicted in FIG. 2A). These forces may bias members 112 and 112′ to translate deeper into electronics housings 208 and 208′ (e.g., into member cavities within electronics housings 208 and 208′), which in turn brings hinge body 104 closer to being encased or at least partially enclosed within recesses 250 and 250′. This may result in the minimum distance between garages 212 and 212′, 256B, being less than 256A at some angles 203B. Similarly, the minimum distance 252 between screens 204 and 204′ may be smaller in configuration 200B than in 200A, depending upon, at least in part, angle 203B.

FIG. 2C illustrates a side view of an example hinge system 202 consistent with at least one embodiment described herein. Hinge system 202 as illustrated in FIG. 2C is in a tablet configuration 200C. Hinge body 104 is partially or completely stowed within recesses 250 and 250′. Continuing the discussion from FIG. 2B above, as the device angle 203 is adjusted from orientation 200B to orientation 200C, members 112 and 112′ may approach antiparallel. Spring 116C may press on electronics housing 208 such that recess 212 is pressed into position around hinge body 104. Note that, in the embodiment illustrated in FIG. 2C, as hinge body 104 may be contained within recesses 250 and 250′, i.e., minimum recess distance 256C may approach zero. Advantageously, minimum screen distance 252C is minimized. Minimum screen distance may be any of a plurality of values, including 5 mm or greater, 10 mm or greater, 30 mm or greater, etc.; in some embodiments, minimum screen distance may approach zero.

FIG. 2D illustrates a side view of an example hinge system 202 consistent with at least one embodiment described herein. Hinge system 202 as illustrated in FIG. 2D is in a “fully open” or “screens out” configuration 200D. Unlike “fully closed” configuration 200A, in configuration 200D screens 204 and 204′ are positioned on the outside. Similar to configuration 200A, springs 116D and 116′D may be at relative maximum compressions, and hinge body 104 may be fully removed from recesses 250 and 250′.

In some embodiments, springs 116 and 116′ may have equilibrium lengths such that they remain in tension throughout operation of hinge system 202. This may, for example, beneficially assist a user attempting to “close” the device (return to configuration 200A). In other embodiments, springs 116 and 116′ may remain in compression (exerting a push at both ends) throughout operation of hinge system 202 (e.g., for all values of angle 203). This may bias the device towards remaining open in the tablet configuration, e.g. 200C. In still other embodiments, springs 116 and 116′ may have equilibrium lengths such that they are in compression for some values of angle 203, and in tension for other values of angle 203. Springs 116 and 116′ may have spring constants (“k-values”) of, for example, 0.1 kg/mm or greater, 0.25 kg/mm or greater, 0.5 kg/mm or greater, 1.5 kg/mm or greater, etc.

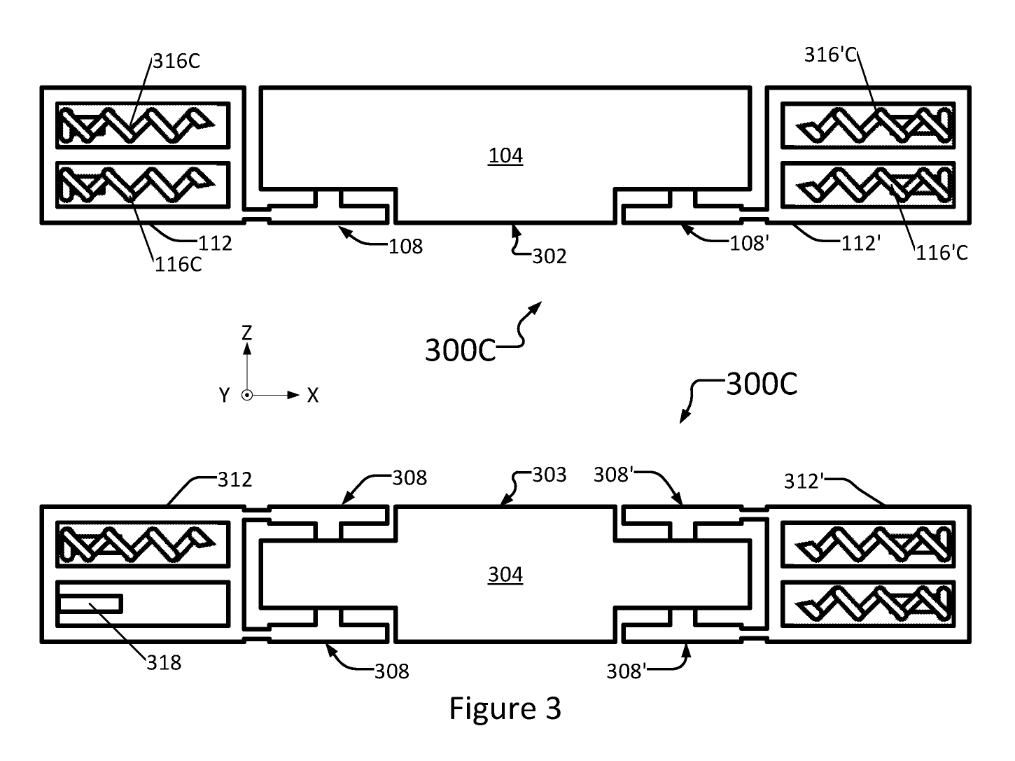

FIG. 3 illustrates a top-down view of example hinge systems 302 and 303, consistent with at least one embodiment described herein. As denoted by the XYZ indicators in FIGS. 1-3, the viewpoint of FIG. 3 is rotated 90 degrees about the X axis relative to the viewpoints of FIGS. 1-2C. FIG. 3 omits depiction of recesses 250 and 250′, electronics housings 208 and 208′, and screens 204 and 204′. FIG. 3 depicts both hinge systems 302 and 303 in tablet orientation 300C, wherein the hinge bodies 104 and 304 may be enclosed by recesses 250 and 250′.

The perspective of FIG. 3 highlights several possible differences between embodiments. For example, hinge system 302 includes an additional spring on each member 112 and 112′, 316C and 316′C. In some embodiments, springs 316C and 316′C have the same or substantially similar (e.g., within 3%) specifications (spring constant (or “k-value”), equilibrium length, etc.) as springs 116C and 116′C, respectively. In other embodiments, springs 316C and 316′C have differing specifications.

Additional springs 316C and 316′C may advantageously allow hinge system 302 to function with springs with lower k-values, which may reduce failures. Further, the spring forces generated by, for example, springs 316C and 116C may provide a more even, reliable resistance, increasing user-friendliness of hinge system 302. In some embodiments, hinge systems such as 302 may also include additional springs (e.g., 4 springs per side, 5 springs per side, etc.).

As can be seen in FIG. 3, members 112 and 112′ may comprise several struts surrounding one or more spring tracks 318. Spring track 318 is visible in hinge system 303, where a spring has been omitted to showcase the track. Track 318 may help prevent the spring from buckling or collapsing under load, and may further enable the spring to exert its forces along a desired axis. In some embodiments, as in hinge system 303, hinges 308 and 308′ may have multiple heads, both of which are connected to their respective members 312 and 312′. This setup may provide additional structural strength to members 312 and 312′. This strength is gained by reducing or counteracting torques about the X axis that may be exerted upon, for example, member 112 resulting from torques about the Z axis. As torques exerted upon members about the Z axis may result from normal operation of the hinge system, this reinforcement may be particularly beneficial.

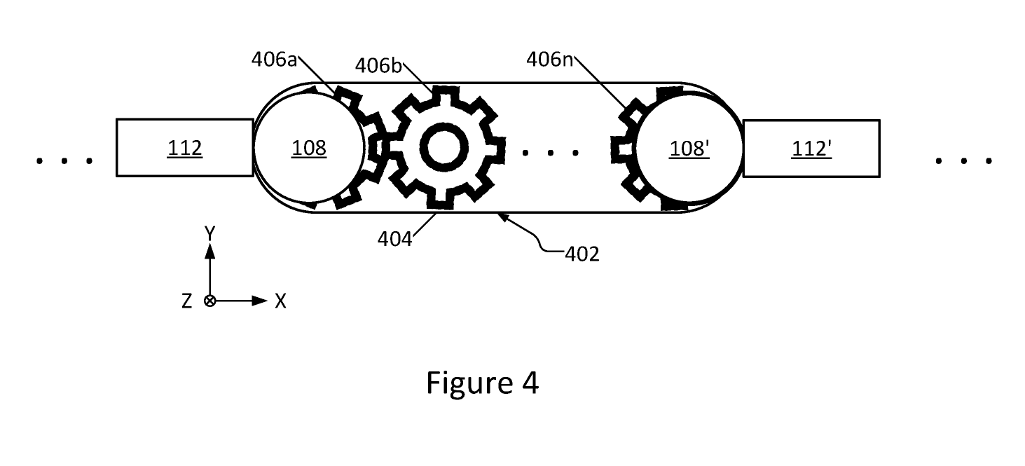

FIG. 4 illustrates a side view of an example synchronous hinge system 402 consistent with at least one embodiment described herein. FIG. 4 omits depiction of springs 116 and 116′ to better focus upon the internal makeup of synchronous hinge system 402. Synchronous hinge system 402 includes a series of gears 406a-406n within hinge body 404. Gears 406a-406n may rotationally “counter-couple” hinge 108 to hinge 108′. For example, in this embodiment, if hinge 108 undergoes positive (e.g., clockwise) rotation about a first rotational axis parallel to the Z axis, gears 406a-406n cause 108′ to undergo negative (e.g., counterclockwise) rotation about a second rotational axis also parallel to the Z axis. The opposite is also true; if hinge 108′ rotates, gears 406a-406n cause hinge 108 rotates about a parallel axis but in the opposite direction.

Synchronous hinge system 402 may be advantageous over other hinge systems because it may enable hinge body 404 to rotate regularly relative to electronics housings 208 and 208′ as the device undergoes changes in configuration (e.g., from a closed configuration to a tablet configuration). This regular rotation may in turn help prevent problems or failures such as, for example, hinge body 204 binding or being caught on the recesses, electronics housings 208 and 208′ colliding with each other, etc. If hinges 108 and 108′ rotate at different rates (i.e., if hinge system 402 were not synchronous), then members 112 and 112′ may extend out of recesses 250 and 250′ at different rates. As in some embodiments the rotation of hinge body 404 may depend upon the rotation of both hinges 108 and 108′, then asynchronous rotation may result in hinge body 404 rotating irregularly relative to the recesses and/or electronics housings. This may result in hinge body 404 being caught on the edges or surfaces of one or both of recesses 250 and/or 250′, hindering operation of the device.

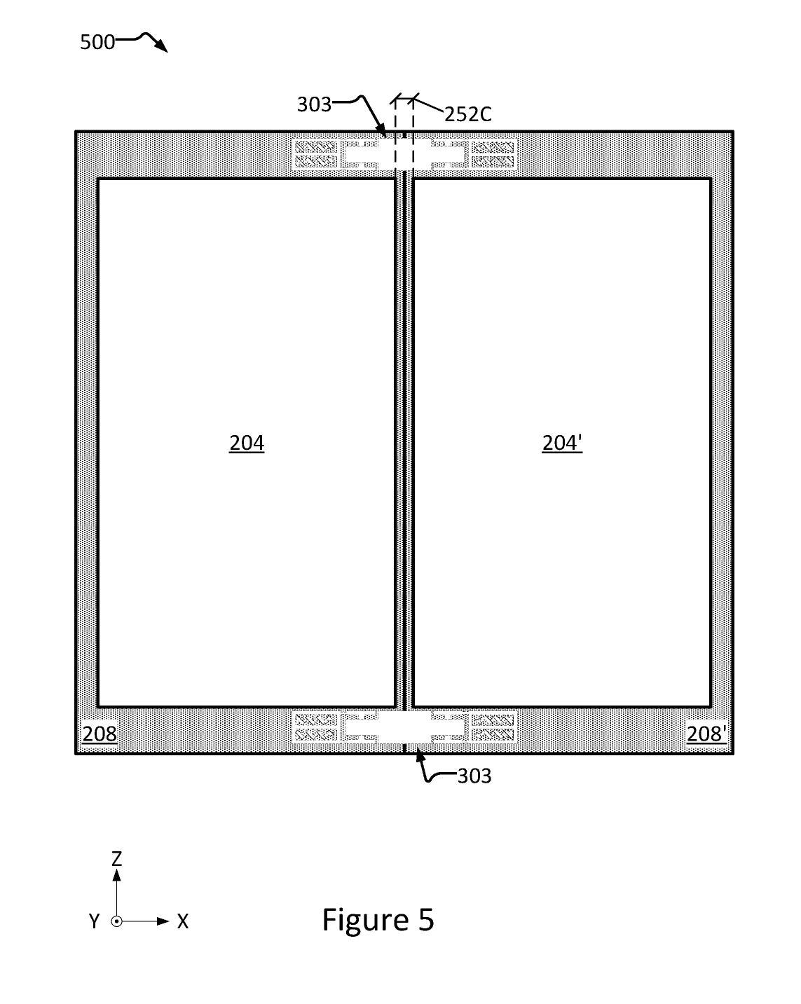

FIG. 5 illustrates a top-down view of an example device 500 that may utilize one or more of the hinge systems consistent with at least one embodiment described herein. Device 500 may be, for example, a folding display device. Device 500 is depicted in FIG. 5 in the tablet configuration, such as configuration 200C. Screens 204 and 204′ may be embedded in, mounted in/upon, or otherwise coupled to electronics housings 208 and 208′, respectively. Screens 204 and 204′ may display content to a user of device 500. Note that device 500 is depicted with two hinge systems 302. This is for exemplary purposes only; embodiments wherein devices such as device 500 include more than two hinge systems are fully considered herein, as are embodiments wherein devices only include a single hinge system.

As device 500 is in the tablet configuration, hinge systems 303 are stowed or enclosed at least partially within recesses of electronics housings 208 and 208′. In some embodiments, hinge systems 303 may be fully enclosed within electronics housing 208 and 208′. In these or other embodiments, hinge systems 303 would ordinarily not be visible in FIG. 5, but have been shown as outlines. In the tablet configuration, gap 252C between screens 204 and 204′ may be minimized. Note that gap 252C is not necessarily zero in this embodiment; this is because the gap between the screens may not be exclusively reliant upon the hinge(s) of device 500. For example, electronics housings 208 and 208′ may include bezels partially or completely surrounding screens 204 and 204′, and these bezels would combine to produce, influence, or otherwise contribute to a gap (such as gap 252C) between the screens, regardless of hinge dimensions or design. However, hinge system 303 as described herein may not have any influence on gap 252C. As such, in some embodiments, gap 252C may approach zero.

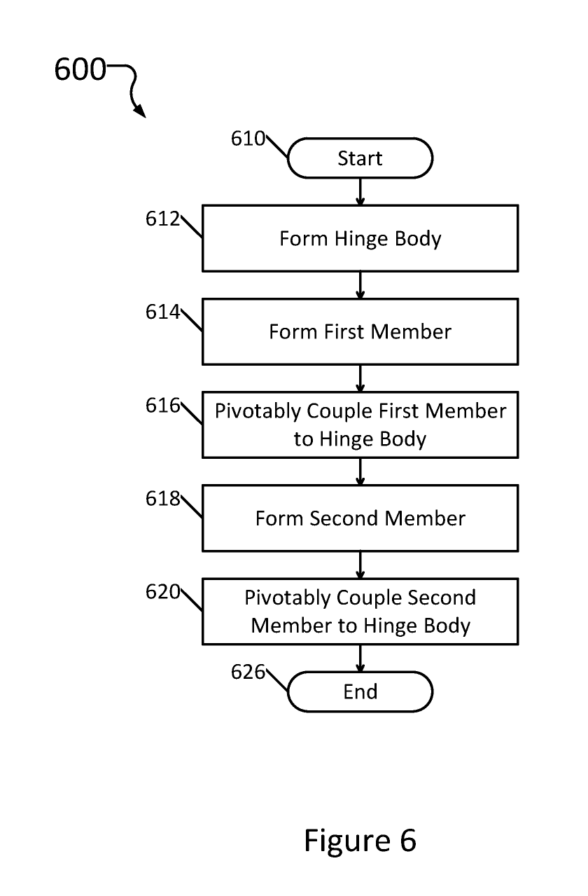

FIG. 6 is a high-level logic flow diagram of an illustrative method 600 of forming a hinge system consistent with at least one embodiment described herein. The hinge system formed via method 600 may be, for example, hinge system 303 of FIG. 3. The method 600 commences at 610.

At 612, a hinge body (such as, for example, hinge body 304) is formed. As described above, hinge body 304 may be formed utilizing, for example, milling, casting, metal injection molding (MIM), additive manufacturing (3D printing), etc. At 614, a first member (such as, for example, first member 312) is formed. As with the other subcomponents of hinge system 303, first member 312 may be made of metals, plastics, composites, etc. and may also be formed utilizing, for example, milling, casting, MIM, 3D printing, etc. At 616, first member 312 is pivotably coupled to hinge body 304. This may be accomplished by coupling first member 312 to a hinge (such as, for example, first hinge 308). This coupling may be accomplished via welding, a mechanical connection (such as a bolt, a chuck, etc.), or in some embodiments hinge 308 and member 312 may be formed as a single entity. In some embodiments, hinge 308 may be a friction hinge.

At 618, a second member (such as, for example, second member 312′) is formed. Second member 312′ may be formed using any of the same methods as first member 312. In some embodiments, second member 312′ is formed using a different method than that used to form first member 312 (e.g., first member 312 may be 3D printed while second member 312′ may be formed via MIM). At 620, second member 312′ is pivotably coupled to hinge body 304. Second member 312′ may be pivotably coupled to hinge body 304 via a second hinge (e.g., second hinge 308′). As with member 312, member 312′ may be coupled to second hinge 308′ via welding, a mechanical connection (such as a bolt, a chuck, etc.), or in some embodiments hinge 308′ and member 312′ may be formed as a single entity.

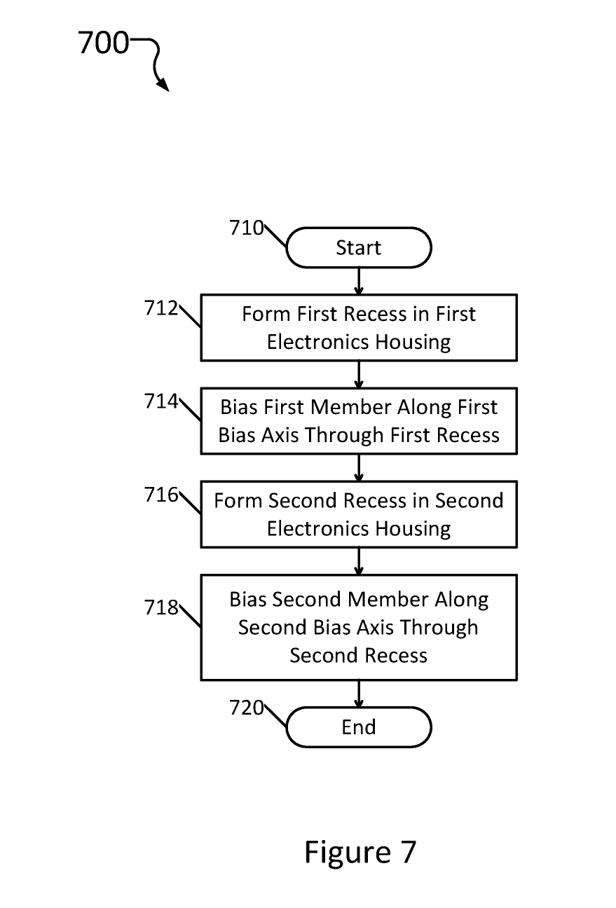

FIG. 7 is a high-level logic flow diagram of an illustrative method 700 of forming a folding display device via rotationally coupling a first electronics housing to a second electronics housing consistent with at least one embodiment described herein. The folding display device formed via method 700 may be, for example, folding display device 500 of FIG. 5 utilizing at least one hinge system 303. Method 700 commences at 710.

At 712, a first recess (such as, for example, first recess 250 of FIGS. 2A-2D) is formed in a first electronics housing. The first electronics housing may be, for example, first electronics housing 208 of any of FIGS. 2A-2D, FIG. 4 and/or FIG. 5. First recess 250 may be formed when first electronics housing 208 is first manufactured (i.e., first electronics housing 208 may be manufactured or formed with first recess 250 already left out), or may be formed after. In some embodiments, first recess 250 is formed when first electronics housing 208 is to be rotationally coupled to a second housing (such as, for example, second housing 208′). First recess 250 may be formed via cutting, shaving, dissolving, lathing, or otherwise removing material from first electronics housing 208.

At 714, a first member (such as, for example, first member 312 of FIG. 3) is biased along a first bias axis through the first recess and at least partially into first electronics housing 208. The first bias axis may be perpendicular to a first axis of rotation. First member 312 may be biased at least partially into first electronics housing 208 via at least one hole, passageway, tunnel, or other gap in the surface at first recess 250.

At 716, a second recess (such as, for example, second recess 250′ of FIGS. 2A-2D) is formed in a second electronics housing. The second electronics housing may be, for example, second electronics housing 208′ of any of FIGS. 2A-2D, FIG. 4 and/or FIG. 5. As with first recess 250 at 712, second recess 250′ may be formed when second electronics housing 208′ is first manufactured (i.e., second electronics housing 208′ may be manufactured or formed with second recess 250′ already left out), or may be formed after. In some embodiments, second recess 250′ is formed when second electronics housing 208′ is to be rotationally coupled to a second housing (such as, for example, first housing 208). Second recess 250′ may be formed via cutting, shaving, dissolving, lathing, or otherwise removing material from second electronics housing 208′.

At 718, a second member (such as, for example, second member 312′ of FIG. 3) is biased along a second bias axis through the second recess 250′ and at least partially into second electronics housing 208′. The second bias axis may be perpendicular to a second axis of rotation. Second member 312′ may be biased at least partially into second electronics housing 208′ via at least one hole, passageway, tunnel, or other gap in the surface at second recess 250′. Once both members 312 and 312′ are biased along their respective bias axes through their respective recesses, method 700 ends at 720. Note that the order of operations described in FIG. 7 is not meant to limit the scope of this disclosure; first and second members and recesses could be swapped with no intended impact on scope.

The following examples pertain to further embodiments. The following examples of the present disclosure may comprise subject material such as at least one apparatus, a method, means for performing acts based on the method and/or a foldable display device.

According to example 1, there is provided a hinge apparatus to pivotably couple first and second electronics housings of a folding display device. The hinge apparatus may include a hinge body; a first member at least partially disposed in a first recess formed in the first electronics housing, the first member pivotably coupled to the hinge body about a first axis of rotation, the first member biased along a first bias axis perpendicular to the first axis of rotation; and a second member at least partially disposed in a second recess formed in the second electronics housing, the second member pivotably coupled to the hinge body about a second axis of rotation, the second axis of rotation parallel to the first axis of rotation, the second member biased along a second bias axis perpendicular to the second axis of rotation.

Example 2 may include elements of example 1 and the apparatus may additionally include: a first spring coupled to the first member along a first spring axis, the first spring axis parallel to the first bias axis; and a second spring coupled to the second member along a second spring axis, the second spring axis parallel to the second bias axis.

Example 3 may include elements of example 2 where: the first spring is further coupled to the first recess; and the second spring is further coupled to the second recess.

Example 4 may include elements of examples 2 or 3 where: the first spring and second springs are at a minimum compression state when the first member is antiparallel to the second member.

Example 5 may include elements of example 4 where: the first and second springs are at a maximum compression state when the first member is parallel to the second member.

Example 6 may include elements of any of examples 1-3 where the hinge body is biased into the first recess and the second recess.

Example 7 may include elements of any of examples 1-3 where the first member and second member are to rotate synchronously about the first axis of rotation and second axis of rotation, respectively.

Example 8 may include elements of example 7 where the hinge body comprises at least a plurality of gears synchronously coupling positive rotation of the first member about the first axis of rotation to negative rotation of the second member about the second axis of rotation, and synchronously coupling negative rotation of the first member about the first axis of rotation to positive rotation of the second member about the second axis of rotation.

Example 9 may include elements of any of examples 1-3 and the apparatus may additionally include: a first friction hinge to pivotably couple the first member to the hinge body; and a second friction hinge to pivotably couple the second member to the hinge body.

Example 10 may include elements of any of examples 1-3 where the first and second members are biased into the first and second recesses along the first and second bias axes, respectively.

Example 11 may include elements of any of examples 1-3 where the first and second members are biased out of the first and second recesses along the first and second bias axes, respectively.

Example 12 may include elements of example 1 where the hinge body, first member and second member are manufactured using at least one of: additive manufacturing; and metal injection molding.

According to example 13, there is provided a foldable display device. The foldable display device may include a first electronics housing comprising a first display and a first recess formed in the first electronics housing; a second electronics housing comprising a second display and a second recess formed in the second electronics housing; and wherein the first electronics housing is rotationally coupled to the second electronics housing using at least one hinge system. The hinge system may include: a hinge body; a first member at least partially disposed in a first recess formed in the first electronics housing, the first member pivotably coupled to the hinge body about a first axis of rotation, the first member biased along a first bias axis perpendicular to the first axis of rotation; and a second member at least partially disposed in a second recess formed in the second electronics housing, the second member pivotably coupled to the hinge body about a second axis of rotation, the second axis of rotation parallel to the first axis of rotation, the second member biased along a second bias axis perpendicular to the second axis of rotation.

Example 14 may include elements of example 13 where: the foldable display device is in a tablet state when the first member is antiparallel to the second member; and the hinge body is at least partially enclosed in the first recess and the second recess when the foldable display device is in the tablet state.

Example 15 may include elements of example 13 where: the foldable display device is in a fully closed state or a fully opened state when the first member is parallel to the second member; and the hinge body is external to the first recess and the second recess when the foldable display device is in the fully closed state or the fully open state.

Example 16 may include elements of any of examples 13-15 and the folding display device may additionally include: a first spring coupled to the first member along a first spring axis, the first spring axis parallel to the first bias axis; and a second spring coupled to the second member along a second spring axis, the second spring axis parallel to the second bias axis.

Example 17 may include elements of example 16 where the first and second springs are at a maximum compression state when the first member is parallel to the second member.

Example 18 may include elements of example 16 where the first and second springs are at a minimum compression state when the first member is antiparallel to the second member.

Example 19 may include elements of example 16 where: the first electronics housing further comprises a first member cavity disposed adjacent the first recess along the first bias axis; the second electronics housing further comprises a second member cavity disposed adjacent the second recess along the second bias axis; the first member is at least partially contained within the first member cavity; and the second member is at least partially contained within the second member cavity.

Example 20 may include elements of example 16 where: the first spring comprises a first end and a second end; the first end of the first spring is coupled to the member at a coupling point within the first member cavity; and the second end of the first spring is coupled to a back wall of the first recess.

Example 21 may include elements of any of examples 13-15 and the folding display device may additionally include: a first friction hinge to pivotably couple the first member to the hinge body; and a second friction hinge to pivotably couple the second member to the hinge body.

Example 22 may include elements of example 21 where: the first friction hinge exerts a first circumferential friction force on the first member about the first axis of rotation; and the second friction hinge exerts a second circumferential friction force on the second member about the second axis of rotation.

Example 23 may include elements of any of examples 13-15 where the first and second members are biased into the first and second recesses along the first and second bias axes, respectively.

Example 24 may include elements of any of examples 13-15 where the first and second members are biased out of the first and second recesses along the first and second bias axes, respectively.

Example 25 may include elements of example 13 where: the hinge body, first member, first hinge, second member and second hinge are manufactured using at least one of: additive manufacturing; and metal injection molding.

According to example 26 there is provided a method. The method may include: forming a hinge system, wherein forming a hinge system may include: pivotably coupling a first member to a hinge body about a first axis of rotation; biasing the first member along a first bias axis, the first bias axis perpendicular to the first axis of rotation; pivotably coupling a second member to the hinge body about a second axis of rotation, the second axis of rotation parallel to the first axis of rotation; and biasing the second member along a second bias axis, the second bias axis perpendicular to the second axis of rotation. The method may further include: forming a first recess in a first electronics housing; forming a second recess in a second electronics housing; and rotationally coupling the first housing to the second housing using the formed hinge system.

According to example 27 there is provided an apparatus. The apparatus may include: means for forming a hinge system, the means for forming a hinge system comprising: means for pivotably coupling a first member to a hinge body about a first axis of rotation; means for biasing the first member along a first bias axis, the first bias axis perpendicular to the first axis of rotation; means for pivotably coupling a second member to the hinge body about a second axis of rotation, the second axis of rotation parallel to the first axis of rotation; and means for biasing the second member along a second bias axis, the second bias axis perpendicular to the second axis of rotation; means for forming a first recess in a first electronics housing; means for forming a second recess in a second electronics housing; and means for rotationally coupling the first housing to the second housing using the formed hinge system.

1. A hinge apparatus to pivotably couple first and second electronics housings of a folding display device, the hinge apparatus comprising:
a hinge body;
a first member at least partially disposed in a first recess formed in the first electronics housing, the first member pivotably coupled to the hinge body about a first axis of rotation, the first member biased along a first bias axis perpendicular to the first axis of rotation; and
a second member at least partially disposed in a second recess formed in the second electronics housing, the second member pivotably coupled to the hinge body about a second axis of rotation, the second axis of rotation parallel to the first axis of rotation, the second member biased along a second bias axis perpendicular to the second axis of rotation.

2. The hinge apparatus of claim 1, further comprising:
a first spring coupled to the first member along a first spring axis, the first spring axis parallel to the first bias axis; and
a second spring coupled to the second member along a second spring axis, the second spring axis parallel to the second bias axis.

3. The hinge apparatus of claim 2, wherein:
the first spring is further coupled to the first recess; and
the second spring is further coupled to the second recess.

4. The hinge apparatus of claim 2, wherein:
the first spring and second springs are at a minimum compression state when the first member is antiparallel to the second member.

5. The hinge apparatus of claim 4, wherein:
the first and second springs are at a maximum compression state when the first member is parallel to the second member.

6. The hinge apparatus of claim 3, wherein the hinge body is biased into the first recess and the second recess.

7. The hinge apparatus of claim 1, wherein the first member and second member are to rotate synchronously about the first axis of rotation and second axis of rotation, respectively.

8. The hinge apparatus of claim 7, wherein the hinge body comprises at least a plurality of gears synchronously coupling positive rotation of the first member about the first axis of rotation to negative rotation of the second member about the second axis of rotation, and synchronously coupling negative rotation of the first member about the first axis of rotation to positive rotation of the second member about the second axis of rotation.

9. The hinge apparatus of claim 1, further comprising:
a first friction hinge to pivotably couple the first member to the hinge body; and
a second friction hinge to pivotably couple the second member to the hinge body.

10. The hinge apparatus of claim 1, wherein the first and second members are biased into the first and second recesses along the first and second bias axes, respectively.

11. The hinge apparatus of claim 1, wherein the first and second members are biased out of the first and second recesses along the first and second bias axes, respectively.

12. The hinge apparatus of claim 1, wherein the hinge body, first member and second member are manufactured using at least one of:
additive manufacturing; and
metal injection molding.

13. A foldable display device, comprising:
a first electronics housing comprising a first display and a first recess formed in the first electronics housing;
a second electronics housing comprising a second display and a second recess formed in the second electronics housing; and
wherein the first electronics housing is rotationally coupled to the second electronics housing using at least one hinge system, the hinge system comprising:
a hinge body;
a first member at least partially disposed in a first recess formed in the first electronics housing, the first member pivotably coupled to the hinge body about a first axis of rotation, the first member biased along a first bias axis perpendicular to the first axis of rotation; and
a second member at least partially disposed in a second recess formed in the second electronics housing, the second member pivotably coupled to the hinge body about a second axis of rotation, the second axis of rotation parallel to the first axis of rotation, the second member biased along a second bias axis perpendicular to the second axis of rotation.

14. The foldable display device of claim 13, wherein:
the foldable display device is in a tablet state when the first member is antiparallel to the second member; and
the hinge body is at least partially enclosed in the first recess and the second recess when the foldable display device is in the tablet state.

15. The foldable display device of claim 13, wherein:
the foldable display device is in a fully closed state or a fully opened state when the first member is parallel to the second member; and
the hinge body is external to the first recess and the second recess when the foldable display device is in the fully closed state or the fully open state.

16. The foldable display device of claim 13, wherein the hinge system further comprises:
a first spring coupled to the first member along a first spring axis, the first spring axis parallel to the first bias axis; and
a second spring coupled to the second member along a second spring axis, the second spring axis parallel to the second bias axis.

17. The foldable display device of claim 16, wherein:
the first and second springs are at a maximum compression state when the first member is parallel to the second member.

18. The foldable display device of claim 16, wherein:
the first and second springs are at a minimum compression state when the first member is antiparallel to the second member.

19. The foldable display device of claim 16, wherein:
the first electronics housing further comprises a first member cavity disposed adjacent the first recess along the first bias axis;
the second electronics housing further comprises a second member cavity disposed adjacent the second recess along the second bias axis;
the first member is at least partially contained within the first member cavity; and
the second member is at least partially contained within the second member cavity.

20. The foldable display device of claim 19, wherein:
the first spring comprises a first end and a second end;
the first end of the first spring is coupled to the member at a coupling point within the first member cavity; and
the second end of the first spring is coupled to a back wall of the first recess.

21. The foldable display device of claim 13, further comprising:
a first friction hinge to pivotably couple the first member to the hinge body; and
a second friction hinge to pivotably couple the second member to the hinge body.

22. The foldable display device of claim 21, wherein:
the first friction hinge exerts a first circumferential friction force on the first member about the first axis of rotation; and
the second friction hinge exerts a second circumferential friction force on the second member about the second axis of rotation.

23. The foldable display device of claim 13, wherein the first and second members are biased into the first and second recesses along the first and second bias axes, respectively.

24. The foldable display device of claim 13, wherein the first and second members are biased out of the first and second recesses along the first and second bias axes, respectively.

25. A method, comprising:
forming a hinge system, wherein forming a hinge system comprises:
pivotably coupling a first member to a hinge body about a first axis of rotation;
biasing the first member along a first bias axis, the first bias axis perpendicular to the first axis of rotation;
pivotably coupling a second member to the hinge body about a second axis of rotation, the second axis of rotation parallel to the first axis of rotation; and
biasing the second member along a second bias axis, the second bias axis perpendicular to the second axis of rotation;
forming a first recess in a first electronics housing;
forming a second recess in a second electronics housing; and
rotationally coupling the first housing to the second housing using the formed hinge system.
